(19) United States
(12) Patent Application Publication
(10) Pub. No.: US 2013/0185429 A1
(43) Pub. Date: Jul. 18, 2013

(54) Processing Store Visiting Data

(71) Applicant: Alibaba Group Holding Limited, Grand Cayman (KY)

(72) Inventors: Panfeng Yuan, Beijing (CN); Cong Ma, Beijing (CN); Xuliang Shi, Beijing (CN); Zhenjie Zhu, Beijing (CN); Maosen Zhang, Beijing (CN)

(73) Assignee: ALIBABA GROUP HOLDING LIMITED, Grand Cayman (KY)

(21) Appl. No.: 13/738,909

(22) Filed: Jan. 10, 2013

(30) Foreign Application Priority Data
Jan. 13, 2012 (CN) 201210065476.4

(51) Int. Cl. H04L 29/08

(52) U.S. Cl. CPC H04L 67/02
USPC 709/225

(57) ABSTRACT

The present disclosure introduces a method and a system for processing store visiting data. New visiting data is obtained. A user ID, a store ID, and a visiting time are analyzed from the new visiting data. It is determined whether the user ID and the store ID match one of user IDs and store IDs in static historical visiting data. If there is a match, it is determined that a user corresponding to the new visiting data is a repeated user of the store. Otherwise, it is then determined whether the user ID and the store ID match one of user IDs and store IDs in dynamic historical visiting data. If there is a match, it is also determined that a user corresponding to the new visiting data is a repeated user of the store.

### CROSS REFERENCE TO RELATED PATENT APPLICATIONS

This application claims foreign priority to Chinese Patent Application No. 201210065476.4 filed on 13 Jan. 2012, entitled “Method and System for Processing Store Visiting Data,” which is hereby incorporated by reference in its entirety.

### TECHNICAL FIELD

The present disclosure relates to the field of computer data processing technology and, more specifically, to a method and a system for processing store visiting data.

### BACKGROUND

Online shopping has become a new shopping trend. More and more persons open online shops at online shopping websites and more and more user shop at the online stores. For example, users from different locations may visit an online store daily. To provide service to the online store, a shopping website may provide statistical data relating to the online store, such as a sale volume of a product, a user visiting volume, a number of users that frequently visit the online store, etc. Through statistics of these data, a seller that opens the online store may timely analyze and adjust types and volume of products and change service based on the data. For example, if a user repeatedly visits the online store during a period of time, the user is a repeated user of the online store. Thus, it may be determined that the user is interested in products of the online store. The seller may analyze data of repeated users to adjust products types and services.

The conventional method for calculating repeated users is as follows. A time period, such as 6 days, to classify a repeated user is determined. Historical visiting data of all users who visit the online store during the time period, such as user identifications (IDs) and online store ID, is obtained. When new user visiting data occurs, a user ID and a visited online store ID in the new visiting data are obtained and compared with the user IDs and the online store IDs in the historical visiting data. If both the user ID and the online shop ID are matched, the user is determined as a repeated user of the online store. Otherwise, the user is not determined as a repeated user of the online store. Under the conventional method, each new user visiting data needs to be compared with the historical visiting data. As the historical visiting data is dynamically changing, data may be disordered at a data source for each matching. The comparison or matching may consume a lot of time and workload, thereby occupying excessive system resources and increasing system burdens. Especially when a number of dynamic changing data in the historical visiting data is high during a short period of time, the conventional method may affect the accuracy of matching, thereby causing inaccurate determination results.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a method and a system for processing store visiting data. The present techniques may improve the accuracy of data processing and reduce requirement of system sources.

The present disclosure provides a method for processing store visiting data. New visiting data is obtained. A user ID, a store ID, and a visiting time are analyzed from the new visiting data.

It is determined whether the user ID and the store ID match one of the user IDs and store IDs in static historical visiting data. If there is a match, it is determined that a user corresponding to the new visiting data is a repeated user of the store. Otherwise, further operations are performed. The static historical visiting data is stored or saved by using a static data structure.

It is then determined whether the user ID and the store ID match one of the user IDs and store IDs in dynamic historical visiting data. If there is a match, it is determined that a user corresponding to the new visiting data is a repeated user of the store. The dynamic historical visiting data is stored or saved by using a dynamic data structure.

The determination of whether the user ID and the store ID match one of the user IDs and store IDs in the static historical visiting data may include the following operations. The store ID in the new visiting data is matched with the store IDs in the static historical visiting data. If there is a match, the user ID in the new visiting data is matched with the user IDs in the static historical visiting data. Otherwise, it is determined that there is no match.

The determination whether the user ID and the store ID match one of user IDs and store IDs in the dynamic historical visiting data may include the following operations. The store ID in the new visiting data is matched with the store IDs in the dynamic historical visiting data. If there is a match, the user ID in the new visiting data is matched with the user IDs in the dynamic historical visiting data. Otherwise, it is determined that there is no match.

For example, the static historical data may include one or more static data structures such as ordered arrays that store information of stores and one or more ordered arrays that store user information of an individual store. The determination of whether the user ID and the store ID match one of user the IDs and store IDs in the static historical visiting data may include the following operations.

The store ID in the new visiting data is matched with data in the ordered arrays that store information of stores. If there is a match, the user ID in the new visiting data is matched with data in the ordered arrays that store user information of the matched store. Otherwise, it is determined that there is no match.

For example, the dynamic historical data may include one or more dynamic data structures such as red-black trees that store information of stores and one or more red-black trees that store user information of an individual store. The determination of whether the user ID and the store ID match one of the user IDs and store IDs in the dynamic historical visiting data may include the following operations.

The store ID in the new visiting data is matched with data in the red-black trees that store information of stores. If there is a match, the user ID in the new visiting data is matched with data in the red-black trees that store user information of the matched store. Otherwise, it is determined that there is no match.

For example, after it is determined that the user corresponding to the new visiting data is the repeated user of the store, the following operations may be performed. If the user corresponding to the new visiting user is the repeated user of the store, a visiting time corresponding to the new visiting data is used to replace a previous time that the user visits the store. Otherwise, the new visiting record is added into the dynamic historical visiting data. The new visiting record may include store information corresponding to the store ID, user information corresponding to the user ID, and the visiting time.

For another example, the present techniques may further include the following operations. A merger processing is conducted to the dynamic historical visiting data and the static historical visiting data. For instance, some or all of the dynamic historical visiting data are stored by using the static data structure to be converted into static historical visiting data and merged with the previous static historical visiting data.

The merger processing may be conducted at a preset time point and/or when a storage volume of the dynamic historical vising data reaches a threshold volume.

For instance, the static historical data may include one or more ordered arrays that store information of stores and one or more ordered arrays that store user information of the single store. The dynamic historical data may include one or more red-black trees that store information of stores and one or more red-black trees that store user information of the single store. The merger processing may include the following operations.

A store is selected from the ordered arrays and the red-black trees that store the store information. A size of the ordered array that stores user information of the store is enlarged. For instance, such size is enlarged to a sum of previous cookies in the order array and cookies in the red-black tree that stores the user information of the store. For instance, the cookies may store information of users that have visited the store. Some or all of the cookies in the red-black tree that stores the user information of the corresponding store is written into the enlarged portion of the ordered array that stores the user information of the corresponding store in order. The previous cookies and the newly written cookies in the ordered array that stores the user information of the corresponding store are ranked according to a hash value of the cookies to form a new ordered array.

The present disclosure also provides a system for processing store visiting data. The system may include an analysis module, a static data determination module, and a dynamic data determination module.

The analysis module obtains new visiting data and analyzes a user ID, a store ID, and a visiting time from the new visiting data.

The static data determination module determines whether the user ID and the store ID match one of the user IDs and store IDs in static historical visiting data. If there is a match, it is determined that a user corresponding to the new visiting data is a repeated user of the store. Otherwise, further operations are performed. The static historical visiting data is stored by using a static data structure.

The dynamic data determination module determines whether the user ID and the store ID match one of the user IDs and store IDs in dynamic historical visiting data. If there is a match, it is determined that a user corresponding to the new visiting data is a repeated user of the store. The dynamic historical visiting data is stored by using a dynamic data structure.

For example, the static data determination module may include an ordered array matching unit that matches the user ID and the store ID with one of the user IDs and store IDs in one or more ordered arrays.

For example, the dynamic data determination module may include a red-black matching unit that matches the user ID and the store ID with one of the user IDs and store IDs in one or more red-black trees.

For another example, the system may also include a processing module. After it is determined that the user corresponding to the new visiting data is the repeated user of the store, the processing module uses a visiting time corresponding to the new visiting data to replace a previous time that the user visits the store. Otherwise, the new visiting record is added into the dynamic historical visiting data. The new visiting record includes store information corresponding to the store ID, user information corresponding to the user ID, and the visiting time.

For another example, the system may also include a merger module. The merger module uses the static data structure to store some or all of the dynamic historical visiting data to convert them into static historical visiting data and merge them with the previous static historical visiting data.

The method and system for processing store vising data divide the historical visiting data into different data structures for storage. The earlier historical visiting data is stored by using the static data structure while the more updated historical visiting data is stored by using the dynamic data structure. The static data structure data is relatively stable data to implement quick searching and reduce requirement of system resources. The dynamic historical visiting data stores real-time changing data to implement quick data storage and updates. The combination of both may increase the efficiency to process the visiting data, reduce the requirement of system resources, improve the precision of the data processing, and ensure the accuracy of the data processing.

In some examples, the historical visiting data may be merged to process at a preset time point or when the storage volume of the dynamic data structure reaches a threshold. For instance, the dynamic historical visiting data may be changed to be stored by using static data structures. The data source is optimized and the occupation of storage space by the dynamic data structures is reduced. The historical visiting data is updated in real time, thereby improving the efficiency of processing store visiting data and reducing the consumption of system resources.

In addition, the static historical visiting data may be stored by the ordered arrays and the dynamic historical visiting data may be stored by the red-black tree. The store information is divided into the ordered arrays and the red-black trees while the user information corresponding to an individual store is also divided into the ordered arrays and the red-black trees. When searching is performed, a step-by-step determination may be implemented. The store is matched first and the user is then matched, thereby improving the search efficiency and implementing the quick processing of data.

It should be noted that a product in accordance with the present disclosure is not necessary to realize all of the above advantages.

### BRIEF DESCRIPTION OF THE DRAWINGS

To better illustrate embodiments of the present disclosure, the following is a brief introduction of figures to be used in descriptions of the embodiments. It is apparent that the following figures only relate to some embodiments of the present disclosure and shall not be used to restrict the present disclosure. A person of ordinary skill in the art can obtain other figures according to the figures in the present disclosure without creative efforts.

FIG. 1 illustrates a diagram of an example system for processing store visiting data in accordance with the present disclosure.

FIG. 2 illustrates flowchart of an example method for processing store visiting data in accordance with a first example embodiment of the present disclosure.

FIG. 3 illustrates flowchart of an example method for processing store visiting data in accordance with a second example embodiment of the present disclosure.

FIG. 4 illustrates a diagram of an example system for processing store visiting data in accordance with the first example embodiment of the present disclosure.

### DETAILED DESCRIPTION

The following is a detailed description of the present techniques by reference to the FIGs. The described embodiments herein are example embodiments and should not be used to restrict the scope of the present disclosure.

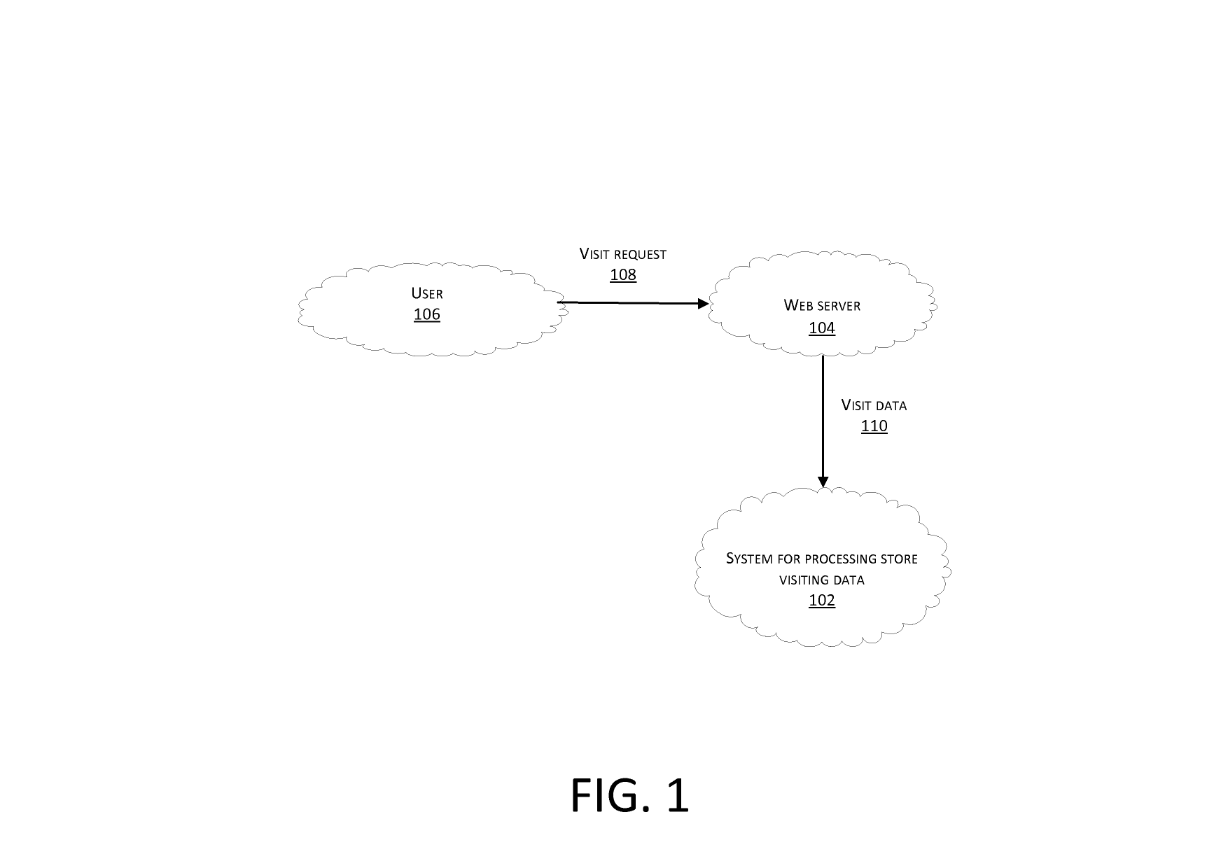

FIG. 1 illustrates a diagram of an example system for processing store visiting data in accordance with the present disclosure. A system 102 for processing store visiting data may be located at a web server 104 or a separate server. When a user 106 sends a visit request 108 to a webpage through a client terminal, the web server 104 records visiting data 110. The system 102 for processing store visiting data obtains the visiting data 110 through real-time information interaction and information such as a user ID, a store ID, and a visiting time from the visiting data 110, and conducts a matching search in historical visiting data. The following is a detailed description of the method and system for processing store visiting data in accordance with the present disclosure.

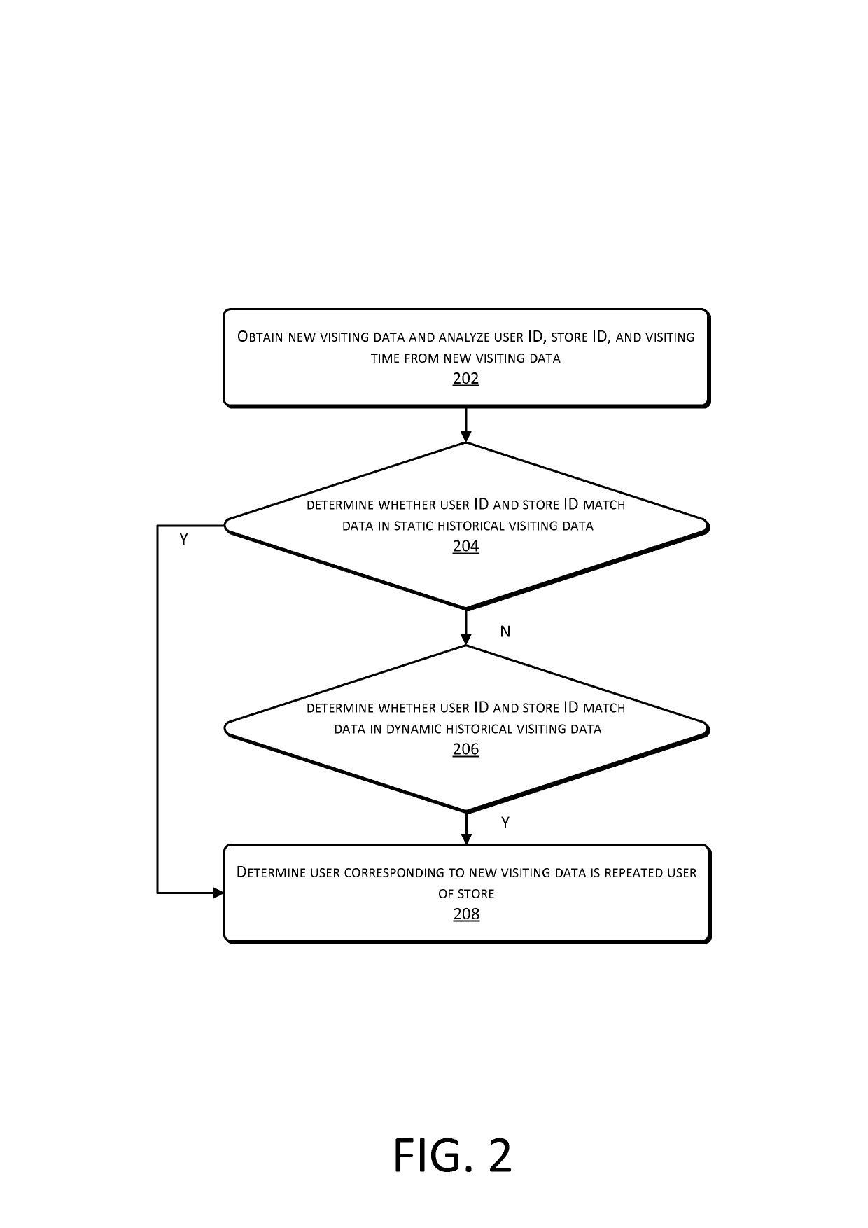

FIG. 2 illustrates flowchart of an example method for processing store visiting data in accordance with a first example embodiment of the present disclosure.

At 202, new visiting data is obtained. A user ID, a store ID, and a visiting time are analyzed from the new visiting data.

When a user visits a shopping website through a client terminal of a web browser, the web server records a visiting request from the client terminal and records and stores the visiting data, such as a cookie ID of the user, a store ID, a requested uniform recourse locator (URL), a visiting time, a version of the client terminal, etc. The system for processing store visiting data may read the visiting data from the web server. The system for processing store visiting data may monitor the visiting status of the web server in real time. When there is new visiting data, the system for processing store visiting data reads the new visiting data and analyzes the user ID, the store ID, and the visiting time from the new visiting data.

For example, to collect the visiting data of the user through the client terminal of a web browser, webpage codes are generally embedded in a log collection script such as in a form of JavaScript. When the user visits the webpage for a first time, the web server conducts session tracking to identify the user such that a cookie is generated for the user and sent to the client terminal of web browser. The web browser will save a key/value of the cookie, which is generally encrypted, into a text file under a local folder of a computer of the user. When the user visits the same website, the cookie is sent to the web server. When the web server generates the cookie for the client terminal of the web browser, the log collection script collects relevant log data when the client terminal visits the web site according to a preset format, such as the cookie ID of the user, a nickname of the user, the visited store ID, the visiting time, a visited webpage, etc. Such collected log data is sent to the webpage server through a HTTP request. The system for processing store visiting data reads the visiting data from the web server, and analyzes the visiting data according to a data storage format to obtain the user ID, the store ID, and the visiting time. The user ID and the store ID are unique identifications to identify the user and the store, and may be represented by specific items based on needs. For instance, the user cookie ID may be regarded as the user identification and the store ID may be regarded as the store identification.

At 204, it is determined whether the user ID and the store ID match one of the user IDs and one of the store IDs in static historical visiting data. If there is a match, it is determined that the user corresponding to the new visiting data is a repeated user of the store. Otherwise, next operations are performed. The static historical visiting data is stored by using a static data structure.

The historical visiting data may be preloaded into system memory and loaded according to a preset rule. For example, if a condition for determining the repeated user is to compare data during a recent 7 days, only data of the recent 7 days is loaded. In addition, after the historical visiting data is loaded, initialized operations may be conducted to the historical visiting data. For instance, historical visiting data not within the preset time period may be deleted to ensure accuracy of determination result. The historical visiting data may have two components. One component is stored by the static data structure, i.e., the static historical visiting data. The other component is stored by the dynamic data structure, i.e., the dynamic historical visiting data. For example, if 7 days are used as a time period, data within the previous 7 days including a current day is historical visiting data. The historical visiting data in the previous 6 days may be stored by using the static data structure. The historical visiting data of the current day (i.e., the visiting data prior to the new visiting data of the current day) may be stored by using the dynamic data structure. For another example, the historical visiting data in the previous 5 days may be stored by using the static data structure. The historical visiting data of the current day and an immediately preceding day may be stored by using the static data structure. Different examples may use different time combinations. The present disclosure does not impose restrictions herein. The data stored in the static data structure, such as the order array, has relatively high indexing efficiency and saves storage space. The data stored in the dynamic data structure, such as the red-black tree, is easy to quick store and fast search. Thus, to implement fast determination and consume little storage space while ensuring fast store and search of new data, a majority of data and earlier data may be stored by using the static data structure when possible. A minority of data and updated data may be stored by using the dynamic data structure.

For example, the user ID and the store ID analyzed from the new visiting data may be matched to the user IDs and the store IDs in each record of the static historical visiting data one pair by one pair. For another example, the store ID analyzed from the new visiting data is firstly matched with the store IDs in the static historical visiting data. If there is a match, the user ID in the new visiting data is then matched with the user IDs corresponding to the store ID in the static historical visiting data. If there is no match, there is no need to match the user ID analyzed from the new visiting data with the static historical visiting data. Operations at 206 may be directly performed.

In another example, the user ID analyzed from the new visiting data may be matched first and then the store IDs corresponding to the user ID in the historical visiting data is searched to find whether there is a matched store ID that is the same as the store ID analyzed from the new visiting data. As the present disclosure relates to the store visiting data, to reduce search volume, in some examples, the store ID may be matched first and the user ID is then matched. This method separates the match of store ID with the match of user ID. As only one of two is matched and then the other is matched, there is no need to conduct one-by-one comparison. Thus, the match scope, the time of search queries, and the workload for searching are reduced, and the search efficiency is improved.

At 206, it is determined whether the user ID and the store ID match one of user the IDs and one of the store IDs in the dynamic historical visiting data. If there is a match, the user ID in the new visiting data is determined as the repeater user of the store. The dynamic historical visiting data is stored by using the dynamic data structure.

If there is no matching record in the static historical visiting data, the matching is continued in the dynamic historical visiting data. The matching may be the same as the matching in the static historical visiting data. That is, the matching may be conducted one by one. Alternatively, one of the store ID and the user ID is selected for matching first and the other one is then matched. The present disclosure does not impose restriction herein.

For example, after it is determined that the user is the repeated user, data record may be conducted according to the determination result. The data record may include the following operations.

If the user analyzed from the new visiting data is the repeated user, a current visiting time analyzed from the new visiting data is used to replace a previous time that the user visits the store. If the user analyzed from the new visiting data is not the repeated user, a current visiting record is added into the dynamic historical visiting data. The current visiting record includes store information corresponding to the store ID, user information corresponding to the user ID, and the current visiting time.

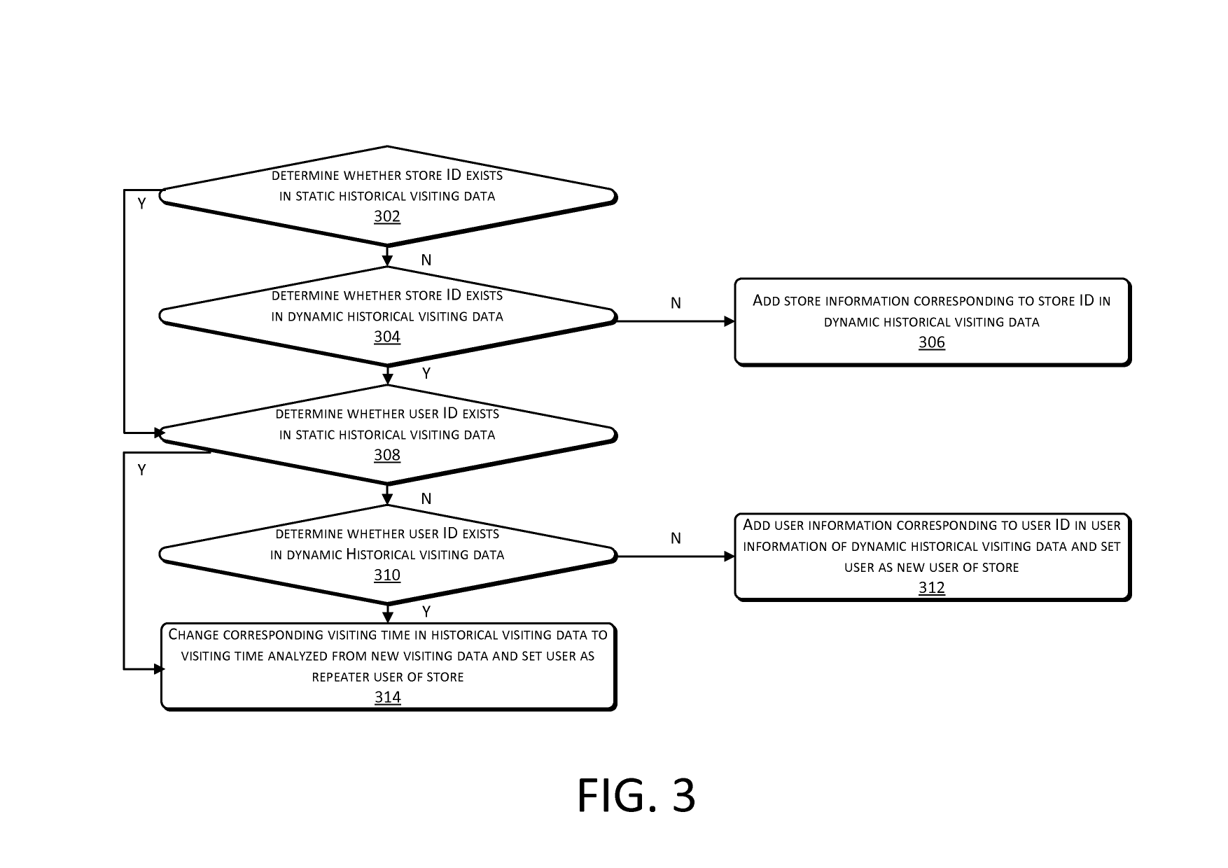

For example, the data record may be added at each determination process in real time. FIG. 3 illustrates a flowchart of an example method for adding a data record in real time in accordance with a second example embodiment of the present disclosure.

At 302, it is determined whether the store ID analyzed from the new visiting data exists in the static historical visiting data. If a determination result is yes, operations at 308 are performed. Otherwise, operations at 304 are performed.

At 304, it is determined whether the store ID analyzed from the new visiting data exists in the dynamic historical visiting data. If a determination result is yes, operations at 308 are performed. Otherwise, operations at 306 are performed.

At 306, store information corresponding to the store is added into the dynamic historical visiting data and operations at 308 are then performed.

At 308, it is determined in the static historical visiting data whether the user ID exists in the user records of the store corresponding to the store ID. If a determination result is yes, operations at 314 are performed. Otherwise, operations at 310 are performed.

At 310, it is determined in the dynamic historical visiting data whether the user ID exists in the user records of the store corresponding to the store ID. If a determination result is yes, operations at 314 are performed. Otherwise, operations at 312 are performed.

At 312, user information corresponding to the user ID is added into user information corresponding to the store in the dynamic historical visiting data and the user is set as a new user of the store.

At 314, the corresponding visiting time in the historical visiting data is replaced by the visiting time corresponding to the new visiting data and the user is set as the repeated user of the store.

If the new visiting data is matched in the static historical visiting data, the visiting time in the static historical visiting data is amended. If the new visiting data is matched in the dynamic historical visiting data, the visiting time in the dynamic historical visiting data is amended.

It should be understood that, at 304, if the store ID exists in the dynamic historical visiting data, the operations may directly jump to 310. According to the storage rules of the historical visiting data, if the store ID does not exist in the static historical visiting data, it can be understood that the store corresponding to the store ID has no user visiting record during the time period corresponding to the static historical visiting data and thus no corresponding user ID exists. As the dynamic historical visiting data may be changed to be stored by the static data structure according to the preset rules, real-time data change may occur during the determination process. (For example, the store ID may be searched in the dynamic historical visiting data. In the later determination, however, the dynamic historical visiting data is switched to the static historical visiting data.) Thus, to ensure the accuracy of the determination result, the process in FIG. 3 may be used in some examples. That is, if the store ID analyzed from the new visiting data does not exist in the static historical visiting data and exists in the dynamic historical visiting data, it is firstly determined in the static historical visiting data whether the user ID analyzed from the new visiting data exists in the user records of the store corresponding to the store ID analyzed from the new visiting data.

For another example, the example methods for processing store visiting data may further include a merger processing to the dynamic historical visiting data and the static historical visiting data.

The merger processing may be conducted at a preset time point and/or when a storage volume of the dynamic historical vising data reaches a threshold volume. The dynamic historical visiting data of the store is converted by using the static data structure for storage to obtain the newly converted static historical visiting data. The newly converted static historical visiting data is merged with the previous static historical visiting data to form new static historical visiting data of the store. The detailed converting process may be determined by the data structures of the static historical visiting data and the dynamic historical visiting data.

For example, when calculating the repeated user, 7 days may be set as a time period. That is, only the historical visiting data within the 7 days is considered. The preset rules may be as follows. The historical visiting data of the first 6 days is stored by using the static data structure and the historical visiting data of the 7^{th} day is stored by using the dynamic data structure. When the 7^{th} day ends and the 8^{th} day starts, such as using 00:00:00 at the 8^{th} day as the time point, according to the preset rules, the historical visiting data between the 2^{nd} day and the 7^{th} day should be stored by using the static data structure. Thus, the dynamic historical visiting data at the 7^{th} day is stored by using the static data structure and is then merged with the static historical visiting data between the 2^{nd} day and the 6^{th} day. In addition, the historical visiting data at the 1^{st} day relative to the 8^{th} day is beyond the preset 7 day period and the historical visiting data at the 1^{st} day may be omitted, such as released or deleted.

For another example, to reduce storage space and server resources, a threshold of dynamic historical visiting data may be preset. In the above scenario, the preset rule is that the visiting data at the 7^{th} day is stored by using the dynamic data structure. However, if the visiting data at the 7^{th} day has a large volume and reaches the preset threshold of dynamic historical visiting data before the next time point, to reduce excessive occupying system resources, some or all of the generated dynamic historical visiting data at the 7^{th} day may be merged with the static historical visiting data of the prior 6 days. That is, the dynamic historical visiting data is stored by using the static data structure to ensure the following visiting data may be stored by using the dynamic data structure.

The following is a detailed illustration of the above example method for processing store visiting data by reference to specific examples.

For example, all historical visiting data of the shopping website is divided into the static historical visiting data (for the prior 6 days) and the dynamic historical visiting data (for the current day) and is stored by using the ordered array and red-black tree data structure. All store information is divided into an ordered array called units and a red-black tree called new_units. The user information of each store is grouped into an ordered array called cookies or a red-black tree called new_cookies. That is, the ordered array units stores the store information visited in the prior 6 days and the red-black tree new_units stores the store information visited in the current day. The ordered array cookies corresponding to each store stores the user information of the users that visited the store in the prior 6 days. The red-black tree new_units store the user information of the user that visited the store at the current day. The store information may include the store represented by the shop_id, a list of cookies, and a newly added list of cookies that is waiting for merger, a last merger time, etc. The user information may include a hash value of the user cookie, a visiting time, a status mark for a repeated user (such as whether the user is a new user of the current day and a number of visiting days), etc.

For example, the process to determine whether a user that sends a new visiting request is a repeated user of the store may be as follows.

At a first step, when there is new visiting data, a user ID (such as the hash value of the cookie), a current visiting time, and a store ID (such as the shop_id) are obtained from the new visiting data. The store ID is matched with data in the ordered array units. If there is a match, a fourth step is performed. Otherwise, a second step is performed.

At the second step, the store ID is matched with data in the red-black tree new_units. If there is a match, the fourth step is performed. Otherwise, a third step is performed.

At the third step, store information corresponding to the store ID is added as a new item into the red-black tree new_units and a fourth step is then performed.

At the fourth step, the user ID is matched with data in the ordered array cookies. If there is a match, a seventh step is performed. Otherwise, a fifth step is performed.

At the fifth step, the user ID is matched with data in the red-black tree new_cookies. If there is a match, the seventh step is performed. Otherwise, a sixth step is performed.

At the sixth step, user information corresponding to the user ID is added as a new item into the red-black tree new_cookies corresponding to the store, and the user is added as a new user of the store.

At the seventh step, a visiting time in the user information is changed to the current visiting time and the user is added as a repeated user of the store.

For instance, the matching in the ordered array may use dichotomy for processing and the matching in the red-black tree may use traversal of tree for processing.

In addition, when the time period reaches the preset time point such that the time period based on days reaches the time point between two days, the dynamic historical visiting data and the static historical visiting data may be merged.

For example, stores are selected one by one from the order array units and the red-black tree new_units that save store information and the data structure represented by shop_node of the current store is obtained. A size of the ordered array cookies is enlarged (i.e., shop_node->cookies is expanded) to include a sum of already included number of cookies and newly added cookies.

After the red-black tree new_cookies (i.e., shop_node->new_cookies) is traversed, the newly added cookies is written into the newly expanded storage units in the shop_node->cookies in order.

The previous and current ordered groups of cookies in the shop_node->cookies are ranked based on respective harsh values of the cookies and then merged to form a new ordered array.

The red-black tree storage units that are added into shop_node->cookies are released from the shop_node->new_cookies.

The shop_node->length is set as equal to previous shop_node->length+shop_node->new_cookies length. The shop_node->new_cookies length is initially set as 0.

In addition, the threshold of dynamic data storage volume may be preset. When the red-black tree new_units or the red-black tree new_cookies reaches the threshold, the data therein is merged into the ordered array units or the ordered array cookies respectively. The detailed merging process is described above.

In this example embodiment, the visiting data of each store is divided into the ordered array and the red-black tree. The visiting data of all stores in the shopping website is also divided into the ordered array and the red-black tree structure. The matching may be implemented in multiple steps such that the store is firstly matched and the user is then matched to improve searching efficiency and to implement quick processing of data. In addition, based on the preset rules, the data are merged at the time point or the storage volume reaches the threshold such that the dynamical historical visiting data is changed to be stored in the static data structure to implement real-time updating of the historical visiting data and to ensure that the new visiting data may be stored by the dynamic data structure. Thus, the store visiting data processing efficiency is guaranteed and the occupation of system resources is reduced.

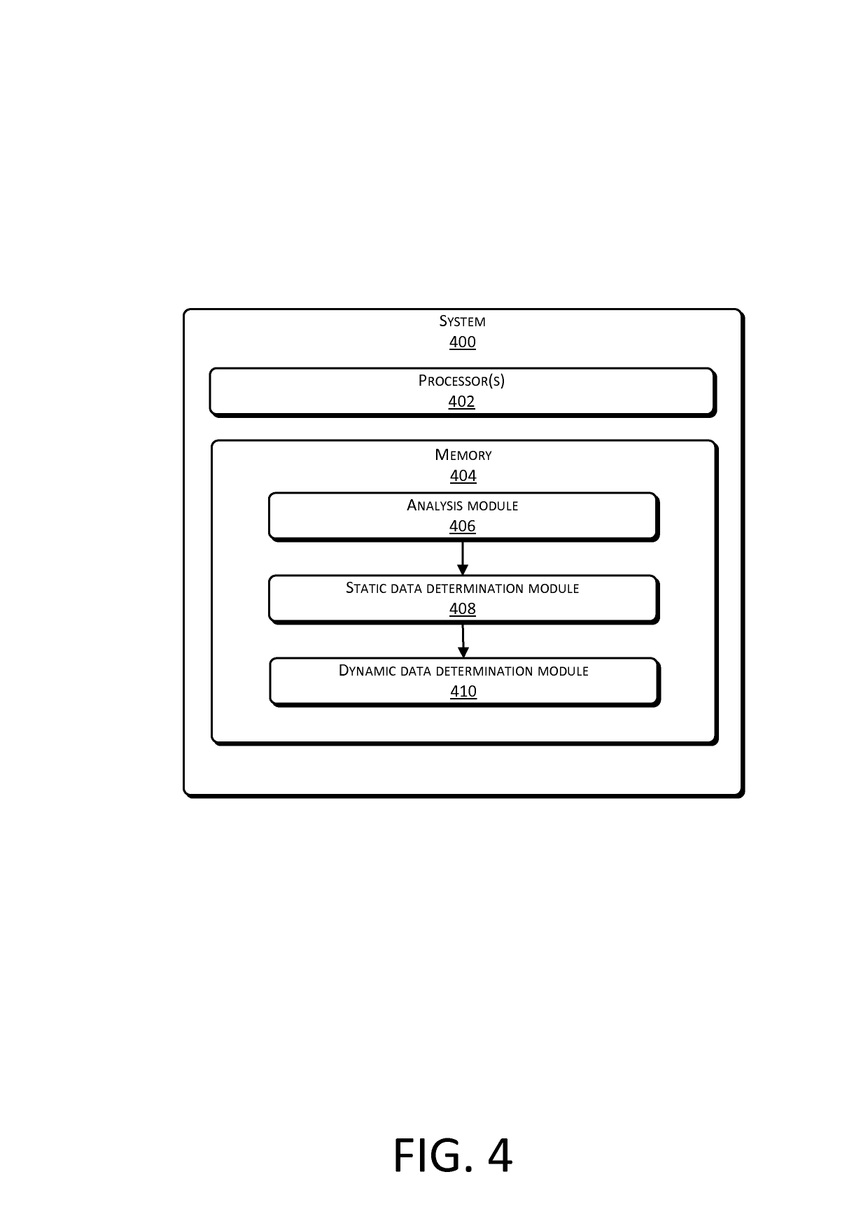

FIG. 4 illustrates a diagram of an example system for processing store visiting data in accordance with the first example embodiment of the present disclosure.

The system may include software, hardware, or a combination thereof. In an example configuration, the system 400 in FIG. 4 may include one or more processor(s) 402 and memory 404. The memory 404 is an example of computer storage media.

Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include transitory media such as modulated data signals and carrier waves.

The memory 404 may store therein program units or modules and program data. In the example of FIG. 4, the memory 404 may store therein an analysis module 406, a static data determination module 408, and a dynamic data determination module 410.

The analysis module 406 obtains new visiting data and analyzes a user ID, a store ID, and a visiting time from the new visiting data.

The static data determination module 408 determines whether the user ID and the store ID match one of the user IDs and store IDs in static historical visiting data. If there is a match, it is determined that a user corresponding to the new visiting data is a repeated user of the store. Otherwise, further operations are performed. The static historical visiting data is stored by using a static data structure. For example, the static data structure may include one or more ordered arrays. The static data determination module 408 may include an ordered array matching unit that matches the store ID and the user ID analyzed by the analysis module 406 with store IDs and user IDs in the one or more order arrays. The matching in the ordered array may use a dichotomy method.

The dynamic data determination module 410 determines whether the user ID and the store ID match one of the user IDs and store IDs in dynamic historical visiting data. If there is a match, it is determined that a user corresponding to the new visiting data is a repeated user of the store. The dynamic historical visiting data is stored by using a dynamic data structure. For example, the dynamic data structure may include one or more red-black trees. The dynamic data determination module 410 may include a red-black matching unit that matches the store ID and the user ID analyzed by the analysis module 406 with store IDs and user IDs in the one or more red-black trees. The matching in the red-black tree may use traversal of tree to process.

For another example, the system may also include a processing module. After it is determined that the user corresponding to the new visiting data is the repeated user of the store, the processing module uses the visiting time corresponding to the new visiting data to replace a previous time that the user visits the store. Otherwise, the new visiting record is added into the dynamic historical visiting data. The new visiting record includes store information corresponding to the store ID, user information corresponding to the user ID, and the visiting time.

For another example, the system may also include a merger module. The merger module merges some or all of the static historical visiting data and the dynamic historical visiting data. The merger module may use the static data structure to store some or all of the dynamic historical visiting data to convert them into static historical visiting data and merge them with the previous static historical visiting data. For another example, the merger module may also include a trigger unit that triggers the merge module to conduct merger processing. The trigger unit may set one or more triggering conditions in advance, such as the time point, the threshold of storage volume, etc. When it is detected that the triggering condition meets, such as the preset time point arrives or the threshold of storage volume reaches, the merger module is triggered to conduct the merger processing.

The present techniques may be described in a context of computer-executable instructions performed by computers, such as program modules. Generally, the program modules include instances, programs, objects, components, and data structures that implement specific tasks or realized specific abstract data types. The present techniques may also be implemented in a distribution computing environment. In the distribution computing environment, remote devices connected by communication networks are used to implement tasks. In the distribution computing environment, the program modules may be stored on local and remote computer storage media including storage devices.

For the purpose of illustration, the above system is described in different modules according to the functionalities. Certainly, the present techniques may implement the functionalities of multiple modules in one or more hardware, software, or in combination of both

The various exemplary embodiments are progressively described in the present disclosure. Same or similar portions of the example embodiments can be mutually referenced. Each example embodiment has a different focus than other example embodiments. In particular, the example system embodiment has been described in a relatively simple manner because of its fundamental correspondence with the example methods. Details thereof can be referred to related portions of the exemplary methods.

From the descriptions of the example embodiments, one of ordinary skill in the art may understand that the present techniques may be implemented through software and necessary general platforms. The present techniques may be embodied in the form of software products. For example, the present disclosure can be in a form of one or more computer programs containing the computer-executable or processor-executable instructions that can be implemented in the computer storage medium (including but not limited to disks, CD-ROM, optical disks, etc.). These computer program instructions can also be loaded in a computer or other programmable data processors, so that the computer or other programmable data processors can perform the methods described in the example embodiments.

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

The example embodiments are merely for illustrating the present disclosure and are not intended to limit the scope of the present disclosure. It should be understood for persons in the technical field that certain modifications and improvements can be made and should be considered under the protection of the present disclosure without departing from the principles of the present disclosure.

What is claimed is:

1. A method performed by one or more processors configured with computer-executable instructions, the method comprising:
obtaining new visiting data;
analyzing a user ID, a store ID, and a visiting time from the new visiting data; and
making a first determination whether the user ID and the store ID analyzed from the new visiting data match a user ID and a store ID in static historical visiting data,
if a result of the first determination is positive, determining that a user corresponding to the user ID in the new visiting data is a repeated user of a store corresponding to the store ID in the new visiting data; and
if a result of the first determination is negative, making a second determination whether the user ID and the store ID analyzed from the new visiting data match a user ID and a store ID in dynamic historical visiting data,
if a result of the second determination is positive, determining that the user corresponding to the user ID in the new visiting data is the repeated user of the store corresponding to the store ID in the new visiting data.

2. The method as recited in claim 1, wherein if a result of the second determination is negative, determining that the user corresponding to the user ID in the new visiting data is a new user of the store corresponding to the store ID in the new visiting data.

3. The method as recited in claim 1, wherein the making the first determination whether the user ID and the store ID analyzed from the new visiting data match the user ID and the store ID in the static historical visiting data comprises:
matching the store ID analyzed from the new visiting data with store IDs in the static historical visiting data;
in response to a determination that the store ID analyzed from the new visiting data matches one of store IDs in the static historical visiting data, matching the user ID analyzed from the new visiting data with user IDs in the static historical visiting data; and
in response to a determination that the user ID analyzed from the new visiting data matches one of user IDs in the static historical visiting data, determining that the result of the first determination is positive.

4. The method as recited in claim 1, wherein the making the second determination whether the user ID and the store ID analyzed from the new visiting data match the user ID and the store ID in the dynamic historical visiting data comprises:
matching the store ID analyzed from the new visiting data with store IDs in the dynamic historical visiting data;
in response to a determination that the store ID analyzed from the new visiting data matches one of store IDs in the dynamic historical visiting data, matching the user ID analyzed from the new visiting data with user IDs in the dynamic historical visiting data; and
in response to a determination that the user ID analyzed from the new visiting data matches one of user IDs in the dynamic historical visiting data, determining that the result of the second determination is positive.

5. The method as recited in claim 1, wherein the static historical data is stored by using a static data structure.

6. The method as recited in claim 1, wherein the static data structure comprises one or more ordered arrays that save store information and one or more ordered arrays that save user information of an individual store.

7. The method as recited in claim 6, wherein the making the first determination whether the user ID and the store ID analyzed from the new visiting data match the user ID and the store ID in the static historical visiting data comprises:
matching the store ID analyzed from the new visiting data with store IDs in the one or more ordered arrays that save the store information;
in response to a determination that the store ID analyzed from the new visiting data matches one of store IDs in the one or more ordered arrays, matching the user ID analyzed from the new visiting data with user IDs in one or more ordered arrays that save user information corresponding to the store; and
in response to a determination that the user ID analyzed from the new visiting data matches one of user IDs in one or more ordered arrays that save user information corresponding to the store, determining that the result of the first determination is positive.

8. The method as recited in claim 1, wherein the dynamic historical data is stored by using a dynamic data structure.

9. The method as recited in claim 1, wherein the dynamic data structure comprises one or more red-black trees that save store information and one or more red-black trees that save user information of an individual store.

10. The method as recited in claim 9, wherein the making the second determination whether the user ID and the store ID analyzed from the new visiting data match the user ID and the store ID in the dynamic historical visiting data comprises:
matching the store ID analyzed from the new visiting data with store IDs in the one or more red-black trees that save the store information;
in response to a determination that the store ID analyzed from the new visiting data matches one of store IDs in the one or more red-black trees, matching the user ID analyzed from the new visiting data with user IDs in one or more red-black trees that save user information corresponding to the store; and
in response to a determination that the user ID analyzed from the new visiting data matches one of user IDs in one or more red-black trees that save user information corresponding to the store, determining that the result of the second determination is positive.

11. The method as recited in claim 1, further comprising:
after determining that the user corresponding to the user ID in the new visiting data is the repeated user of the store, replacing a prior visiting time of the user to the store in the static historical visiting data or the dynamic historical visiting data by the visiting time analyzed from the new visiting data.

12. The method as recited in claim 1, further comprising:
after determining that the user corresponding to the user ID in the new visiting data is the new user of the store, adding a new visiting record into the dynamic historical visiting data, the new visiting record including the user ID, the store ID, and the visiting time analyzed from the new visiting data.

13. The method as recited in claim 1, further comprising merging some or all of the dynamic historical visiting data with the static historical visiting data, the merging including:
saving some or all of the dynamic historical visiting data by using static data structure to convert the some or all of the dynamic historical visiting data into new static historical visiting data; and
merging the new static historical visiting data with the static historical visiting data.

14. The method as recited in claim 13, wherein the merging is conducted when a storage volume of the dynamic historical visiting data reaches a preset threshold.

15. The method as recited in claim 13, wherein:
the static historical visiting data comprises one or more ordered arrays that save store information and one or more ordered arrays that save user information of an individual store;
the dynamic data structure comprises one or more red-black trees that save store information and one or more red-black trees that save user information of an individual store; and
the merging comprises:
selecting the store from the one or more arrays that save the store information and the one or more red-black trees that save the store information;
enlarging a size of an ordered array that store user information corresponding to the store to include a space for user information corresponding to the store saved in a red-black tree;
writing some or all of the user information corresponding to the store saved in the red-black tree into the space of the enlarged ordered array;
ranking previously saved user information in the enlarged ordered array and the written user information in the enlarged ordered arrays to form a new ordered array.

16. The method as recited in claim 15, wherein the ranking comprises using respective hash values of the previously saved user information in the enlarged ordered array and the written user information in the enlarged ordered arrays to form a new ordered array.

17. A system comprising:
an analysis module that obtains new visiting data and analyzes a user ID, a store ID, and a visiting time from the new visiting data;
a static data determination module that makes a first determination whether the user ID and the store ID match one of user IDs and store IDs in static historical visiting data, determines that a user corresponding to the new visiting data is a repeated user of the store if a result of the first determination is a match, and requests a dynamic data determination module to make a second determination if the result of the first determination is not a match; and
a dynamic data determination module that makes the second determination whether the user ID and the store ID match one of user IDs and store IDs in dynamic historical visiting data, determines that the user corresponding to the new visiting data is the repeated user of the store if a result of the second determination is a match.

18. The system as recited in claim 17, further comprising a processing module that uses the visiting time corresponding to the new visiting data to replace a previous time that the user visits the store after it is determined that the user corresponding to the new visiting data is the repeated user of the store, or adds a new visiting record into the dynamic historical visiting data after it is determined that the user corresponding to the new visiting data is the new user of the store, the new visiting record includes store information corresponding to the store ID, user information corresponding to the user ID, and the visiting time.

19. The system as recited in claim 17, further comprising a merger module that uses a static data structure to store some or all of the dynamic historical visiting data to convert the some or all of the dynamic historical visiting data into new static historical visiting data and merge the new static historical visiting data with the static historical visiting data.

20. One or more computer storage media including processor-executable instructions that, when executed by one or more processors, direct the one or more processors to perform a method comprising:
obtaining new visiting data;
analyzing a user ID, a store ID, and a visiting time from the new visiting data; and
making a first determination whether the user ID and the store ID analyzed from the new visiting data match a user ID and a store ID in static historical visiting data,
if a result of the first determination is positive, determining that a user corresponding to the user ID in the new visiting data is a repeated user of a store corresponding to the store ID in the new visiting data; and
if a result of the first determination is negative, making a second determination whether the user ID and the store ID analyzed from the new visiting data match a user ID and a store ID in dynamic historical visiting data,
if a result of the second determination is positive, determining that the user corresponding to the user ID in the new visiting data is the repeated user of the store corresponding to the store ID in the new visiting data.
